(19) United States
(12) Patent Application Publication
(10) Pub. No.: US 2026/0313428 A1
(43) Pub. Date: Oct. 8, 2026

(54) USER EQUIPMENT CAPABILITY INDICATION FOR EARLY CHANNEL STATE INFORMATION (CSI)-REFERENCE SIGNAL BASED CSI ACQUISITION

(71) Applicant: QUALCOMM Incorporated, San Diego, CA (US)

(72) Inventors: In-Soo KIM, San Diego, CA (US); Yan ZHOU, San Diego, CA (US); Jing JIANG, San Diego, CA (US)

(21) Appl. No.: 19/636,591

(22) Filed: Apr. 1, 2026

Related U.S. Application Data
(60) Provisional application No. 63/785,305, filed on Apr. 8, 2025.

(51) Int. Cl. H04W 24/10; H04W 74/0833

(52) U.S. Cl. CPC H04W 24/10; H04W 74/0833

(57) ABSTRACT

This disclosure provides methods, components, devices and systems for user equipment (UE) capability indication for early channel state information (CSI)-reference signal (RS) based CSI acquisition. For example, a user equipment (UE) may transmit, during a physical random access channel (RACH) procedure, a message that comprises information indicative of a support for an early CSI measurement and reporting procedure. The UE may receive, during the RACH procedure, a signal that configures one or more CSI-RS transmissions based at least in part on the message. The UE may perform, during the RACH procedure and prior to a radio resource control (RRC) setup complete message associated with the RACH procedure, the early CSI measurement and reporting procedure using the one or more CSI-RS transmissions.

### CROSS REFERENCE

The present Application for Patent claims the benefit of U.S. Provisional Patent Application No. 63/785,305 by KIM et al., entitled “USER EQUIPMENT CAPABILITY INDICATION FOR EARLY CHANNEL STATE INFORMATION (CSI)-REFERENCE SIGNAL BASED CSI ACQUISITION,” filed Apr. 8, 2025, assigned to the assignee hereof, and expressly incorporated by reference herein.

### TECHNICAL FIELD

This disclosure relates generally to wireless communication, and more specifically to systems, devices, methods, and techniques associated with user equipment capability indication for early channel state information (CSI)-reference signal-based CSI acquisition.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method for wireless communications by a user equipment (UE) is described. The method may include transmitting, during a random access channel (RACH) procedure, a message that includes information indicative of a support for an early channel state information (CSI) measurement and reporting procedure, receiving, during the RACHRACH procedure, a signal that configures one or more CSI-reference signal (RS) transmissions based on the message, and performing, during the RACHRACH procedure and prior to a radio resource control (RRC) setup complete message associated with the RACHRACH procedure, the early CSI measurement and reporting procedure using the one or more CSI-RS transmissions.

A UE for wireless communications is described. The UE may include a processing system that includes processor circuitry and memory circuitry that stores code. The processing system may be configured to cause the UE to transmit, during a RACH procedure, a message that includes information indicative of a support for an early CSI measurement and reporting procedure, receive, during the RACH procedure, a signal that configures one or more CSI-RS transmissions based on the message, and perform, during the RACH procedure and prior to an RRC setup complete message associated with the RACH procedure, the early CSI measurement and reporting procedure using the one or more CSI-RS transmissions.

Another UE for wireless communications is described. The UE may include means for transmitting, during a RACH procedure, a message that includes information indicative of a support for an early CSI measurement and reporting procedure, means for receiving, during the RACH procedure, a signal that configures one or more CSI-RS transmissions based on the message, and means for performing, during the RACH procedure and prior to an RRC setup complete message associated with the RACH procedure, the early CSI measurement and reporting procedure using the one or more CSI-RS transmissions.

A non-transitory computer-readable medium storing code for wireless communications is described. The code may include instructions executable by one or more processors to transmit, during a RACH procedure, a message that includes information indicative of a support for an early CSI measurement and reporting procedure, receive, during the RACH procedure, a signal that configures one or more CSI-RS transmissions based on the message, and perform, during the RACH procedure and prior to an RRC setup complete message associated with the RACH procedure, the early CSI measurement and reporting procedure using the one or more CSI-RS transmissions.

In some examples of the method, user equipment (UEs), and non-transitory computer-readable medium described herein, transmitting the message may include operations, features, means, or instructions for selecting resources of a RACH occasion (RO) that correspond to a level of support for the early CSI measurement and reporting procedure.

Some examples of the method, user equipment (UEs), and non-transitory computer-readable medium described herein may further include operations, features, means, or instructions for receiving a second message that triggers reporting of information associated with the support for the early CSI measurement and reporting procedure, where transmitting the message may be based on the second message.

A method for wireless communications by a UE is described. The method may include monitoring for a synchronization signal block (SSB) transmission according to an SSB periodicity and synchronization raster configuration associated with a set of multiple SSB transmissions, where one or more parameters of the SSB periodicity and synchronization raster configuration are based on a frequency range, on a frequency band, on a subcarrier spacing (SCS), or any combination thereof, associated with the set of multiple SSB transmissions, receiving at least one SSB transmission according to the SSB periodicity and synchronization raster configuration, and performing a RACH procedure based on the at least one SSB transmission.

A UE for wireless communications is described. The UE may include a processing system that includes processor circuitry and memory circuitry that stores code. The processing system may be configured to cause the UE to monitor for a SSB transmission according to an SSB periodicity and synchronization raster configuration associated with a set of multiple SSB transmissions, where one or more parameters of the SSB periodicity and synchronization raster configuration are based on a frequency range, on a frequency band, on a SCS, or any combination thereof, associated with the set of multiple SSB transmissions, receive at least one SSB transmission according to the SSB periodicity and synchronization raster configuration, and perform a RACH procedure based on the at least one SSB transmission.

Another UE for wireless communications is described. The UE may include means for monitoring for a SSB transmission according to an SSB periodicity and synchronization raster configuration associated with a set of multiple SSB transmissions, where one or more parameters of the SSB periodicity and synchronization raster configuration are based on a frequency range, on a frequency band, on a SCS, or any combination thereof, associated with the set of multiple SSB transmissions, means for receiving at least one SSB transmission according to the SSB periodicity and synchronization raster configuration, and means for performing a RACH procedure based on the at least one SSB transmission.

A non-transitory computer-readable medium storing code for wireless communications is described. The code may include instructions executable by one or more processors to monitor for a SSB transmission according to an SSB periodicity and synchronization raster configuration associated with a set of multiple SSB transmissions, where one or more parameters of the SSB periodicity and synchronization raster configuration are based on a frequency range, on a frequency band, on a SCS, or any combination thereof, associated with the set of multiple SSB transmissions, receive at least one SSB transmission according to the SSB periodicity and synchronization raster configuration, and perform a RACH procedure based on the at least one SSB transmission.

In some examples of the method, user equipment (UEs), and non-transitory computer-readable medium described herein, the one or more parameters include a periodicity of the set of multiple SSB transmissions according to the SSB periodicity and synchronization raster configuration.

### BRIEF DESCRIPTION OF THE DRAWINGS

FIG. 1 shows an example of a wireless communication system.

FIG. 2 shows an example of a diagram that supports user equipment (UE) capability indication for early channel state information (CSI)-reference signal (RS) based CSI acquisition.

FIG. 3 shows an example of a diagram that supports UE capability indication for early CSI-RS based CSI acquisition.

FIG. 4 shows an example of a diagram that supports UE capability indication for early CSI-RS based CSI acquisition.

FIG. 5 shows an example of a diagram that supports UE capability indication for early CSI-RS based CSI acquisition.

FIG. 6 shows an example of a diagram that supports UE capability indication for early CSI-RS based CSI acquisition.

FIG. 7 shows a block diagram of a processing system that supports UE capability indication for early CSI-RS based CSI acquisition.

FIG. 8 shows a diagram of a system including a device that supports UE capability indication for early CSI-RS based CSI acquisition.

FIGS. 9 through 11 show flowcharts illustrating methods that support UE capability indication for early CSI-RS based CSI acquisition.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, random access channel (RACH) procedures (also referred to as physical random access channel (PRACH) procedures) may be implemented for initial access for user equipment (UE). For example, a UE may be initially powering on and/or may be operating in a radio resource control (RRC) idle or inactive mode such that the UE does not have an active connection with the network. The UE may transmit (e.g., to initiate establishment of the wireless connection to the network) a RACH message one (Msg1) to the network by randomly selecting a RACH preamble to transmit via the RACH. The network may respond with a RACH message two (Msg2), which triggers a RACH message three (Msg3) (e.g., a RRC setup request) from the UE. The network may respond with a RACH message four (Msg4) (e.g., a RRC setup message). The UE may respond with a RACH message five (Msg5) (e.g., a RRC setup complete) message, which may then initiate authentication and security procedures and registration procedures to establish the wireless connection with the network. However, the steps of the RACH procedure are generally performed without knowledge of the performance characteristics of the wireless channel between the UE and the network. This may limit the parameters used for communicating such messages (e.g., using a narrower bandwidth, using a lower modulation and coding scheme (MCS), using fewer or only one antenna port, and others). This may create latency issues for the wireless communications between the UE and the network.

Aspects of the subject matter described in this disclosure relate to early channel state information-reference signal (CSI-RS) based CSI acquisition between the UE and the network (e.g., during the RACH procedure). For example, the described techniques generally provide for the UE to signal its support for early CSI-RS based channel measurement and reporting early in the RACH procedure (e.g., in the RACH Msg1 and/or the RACH Msg3 of the four-step RACH procedure or in a message A (MsgA) of a two-step RACH procedure). This early indication of support may allow the UE to be scheduled with CSI-RS transmissions during the RACH procedure and then channel performance feedback (e.g., a CSI reporting) either during the RACH procedure or immediately after the RACH procedure. The described techniques may provide for early detection of the channel performance, which may enable faster selection of improved communication parameters (e.g., to configure the subsequent RACH messages for a higher throughput).

For example, the UE may transmit a message during the RACH procedure that indicates support for the early CSI measurement and reporting procedure. The UE may receive a signal that configures CSI-RS transmission(s) during the RACH procedure and perform the early CSI measurement and reporting procedure using the CSI-RS transmission(s). For example, the UE may perform the early CSI measurement and reporting procedure during the RACH procedure (e.g., prior to receipt of the RRC setup complete message).

Particular aspects of the subject matter described in this disclosure can be implemented to realize one or more of the following potential advantages. In some examples, by indicating support for the early CSI measurement and reporting procedure early in the RACH procedure, the described techniques can be used to estimate the channel performance and update the communication parameters and/or allocations during the RACH procedure. The indication of support for the early CSI measurement and reporting procedure may reduce the latency associated with the UE and enable more rapid and additional information communications between the UE and the network.

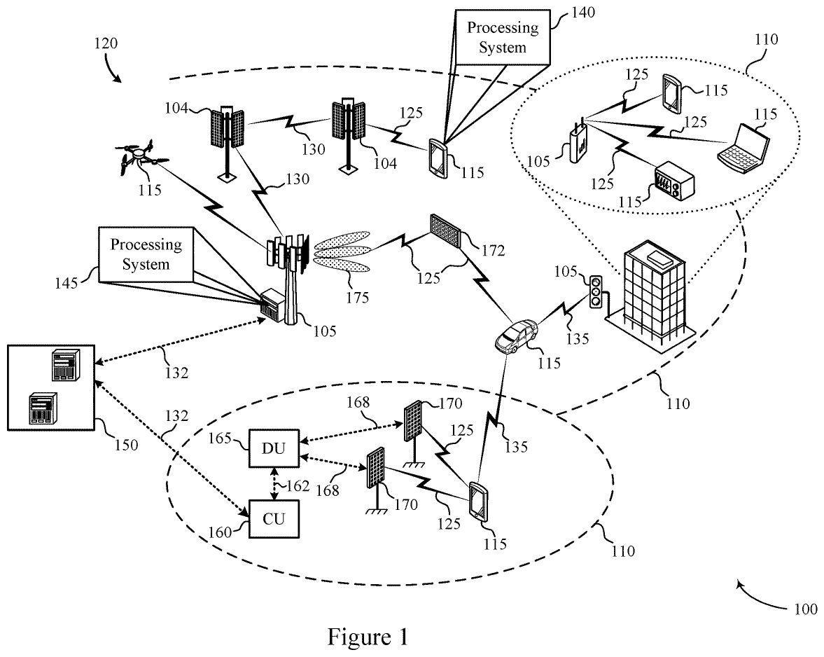

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a Radio Resource Control (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105 and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration) or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects of the described techniques for UE capability indication for early CSI-RS based CSI acquisition. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the wireless communication system 100 (such as the RAN 120) may support reduced latency for wireless communications between the UE 115 and the network entity 105. The UE's indication of support for the early CSI measurement and reporting procedure may trigger CSI-RS transmissions from the network entity 105 during the RACH procedure. The UE 115 reporting the measurement results (e.g., in a CSI report) may provide the information used to improve the communication parameters and/or allocation operations of the wireless network to maximally utilize the channel performance characteristics (e.g., rather than adopting a default set of communication parameters and/or allocations based on a lack of knowledge of the channel performance).

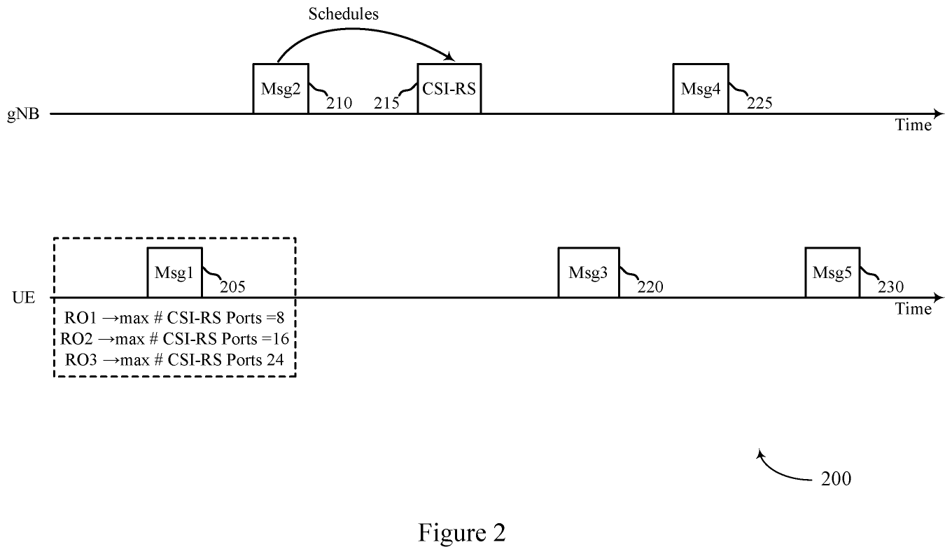

FIG. 2 shows an example of a diagram 200 that supports UE capability indication for early CSI-RS based CSI acquisition. Aspects of the diagram 200 may be implemented by aspects of and/or may implement aspects of the wireless communication system 100. For example, aspects of the diagram 200 may be implemented by and/or may be implemented at a UE or a network entity (e.g., a gNB), which may be examples of the corresponding devices described herein.

Wireless networks may use a four-step access procedure (e.g., a RACH procedure) or a two-step access procedure to (re)establish a connection between the UE and the gNB. The four-step RACH procedure may begin with the UE randomly selecting a RACH preamble and transmitting the preamble on the RACH in a RACH message one (Msg1). The UE may be operating in an RRC idle or inactive mode and transmit the RACH preamble (e.g., the RACH Msg1) to reestablish a connection with the gNB. The UE may be moving from one cell to another and transmit the RACH preamble (e.g., the RACH Msg1) to establish a connection with the new serving cell. The gNB may respond to the RACH preamble by transmitting a RACH message two (Msg2) (which may also be referred to as a random access response (RAR)) to the UE. The RACH Msg2 may carry or otherwise convey information that indicates whether the RACH preamble was successfully detected and decoded by the gNB. In some cases, the RACH Msg2 may also provide instructions regarding the next step (e.g., provide an indication of uplink channel resource for the next UE transmission).

Accordingly, the UE may transmit a RACH Msg3 (e.g., a PUSCH) in response to the RACH Msg2 and according to the information indicated in the RACH Msg2 (e.g., using the PUSCH resources indicated in the RACH Msg2). The gNB may transmit a RACH Msg4 (e.g., a contention resolution message) in response to the RACH Msg3. The RACH Msg4 generally includes a PDCCH portion and a PDSCH portion that collectively may be referred to as the RACH Msg4. The RACH Msg4 generally indicates or otherwise confirms successful completion of the RACH procedure and provides additional information to be used for further communications.

The two-step RACH procedure may include the UE transmitting a RACH message A (MsgA) to initiate the connection (re)establishment procedure and the gNB responding with a RACH message B (MsgB).

However, there may be an associated coverage limit based on the initial access channels (e.g., the RACH and/or other channels used for either RACH procedure). Generally, this may be based on an unknown channel condition for the wireless channel between the UE and the gNB. That is, as the UE was in an RRC idle or inactive state and/or may be moving to a new serving cell, the performance characteristics of the wireless channel between the UE and the gNB may be unknown to the UE and to the gNB. This may result in a coverage limitation related to the initial access related channels (e.g., in wireless networks operating in the 4 GHz, 8 GHz, and/or 28 GHz frequency ranges). In the downlink, a broadcast PDCCH and PDSCH may have a sub-optimal precoder applied due to the unknown channel condition. In the uplink, the link budget for the RACH Msg3 and the RACH Msg4 acknowledgement (ACK) message may be degraded if the gNB cannot combine all digital ports.

Accordingly, it may be beneficial to support an early CSI acquisition procedure for the wireless network. To implement early CSI-RS reception and/or channel state feedback (CSF), the UE may be capable of measuring the CSI-RS resource sets as well as reporting the CSI metrics, etc., that were configured and/or otherwise scheduled by the gNB. This may include the CSI-RS and CSI-interference management (IM) transmission reception by the UE for CSI feedback. The UE may be capable of supporting a maximum number of configured non-zero power (NZP)-CSI-RS resources on a per component carrier (CC) basis. The UE may be capable of supporting a maximum number of ports across all configured NZP-CSI-RS resources on a per CC basis. The UE may be capable of supporting a maximum number of simultaneous NZP-CSI-RS resources on a per CC basis.

For the CSI feedback (e.g., the CSI report framework), the UE may be capable of supporting a maximum number of aperiodic CSI report settings per-BWP for the CSI report. The UE may be capable of supporting the maximum number of configured aperiodic CSI triggering states indicated in a CSIAperiodicTriggerStateList information element (IE) on a per CC basis. The UE may may support processing Y CSI report(s) simultaneously in a CC. The UE may support CSI reports that are periodic, semi-persistent, and/or aperiodic in nature and any latency class and codebook type. This support may be associated with a Type I single panel codebook, a Type I multi-panel codebook, a Type II codebook, and/or a Type II codebook with port selection.

As discussed above with regards to the four-step RACH procedure, there may be an earliest point at which CSI reporting is enabled for the UE (re)establishing a connection with the gNB via the access procedure. In some cases, the earliest CSI-RS transmission timeline for idle UE RRC setup may happen only after the RRC reconfiguration message (reconfig) based on the UE capability. This may involve lengthy authentication and security processes. In some cases, the earliest CSI-RS transmission time for inactive UE RRC resume may happen after the RRC resume complete in Msg5. The RRC resume in Msg4 can update the RRC parameters based on the network stored UE capability. Downlink and/or uplink data can flow after the RRC resume complete message. In some cases, no CSI-RS or CSI can be triggered during an inactive UE small data transmission (SDT), which only supports using the fallback DCI format. The downlink response for the RRC resume request may not contain any RRC message to update RRC parameters for CSI-RS or CSF. The downlink response can be the Msg4 in RACH based SDT, or DCI scheduling dynamic grant after the initial control function (CF) transmission in CF based SDT.

Accordingly, aspects of the described techniques may support the UE and network acquiring the CSI as early as possible where the gNB may configure and/or schedule the early CSI-RS for CSF at least before the RRC connection setup complete message. After the UE reports the CSI metrics (e.g., the CSI report), the gNB may optimize the precoder, MCS, etc., for downlink messages, such as the RACH Msg2, the RACH Msg4, and/or the RACH MsgB. In some aspects, the described techniques for CSI-RS reception and CSF may be based on the UE capabilities, such as the maximum number of CSI-RS ports, resources, etc., that the UE can measure. For the gNB to know the UE capability before the RRC connection setup complete message, the UE may indicate the CSI-RS reception/CSF capability in uplink signals and/or messages, such as in the RACH Msg1 via the RACH, the RACH MsgA via the RACH, the RACH MsgA via the PUSCH, and/or the RACH Msg3 via the PUSCH.

Accordingly, the techniques described herein provide for a UE capability indication scheme that supports early CSI-RS-based CSI acquisition. In some cases, this may include the UE indicating the CSI-RS reception/CSF capabilities in uplink signals and/or messages at least before the RRC connection setup complete message. The UE may provide the capability indication in a RACH Msg1/A RACH, in a MsgA/3 PUSCH, in an enhanced Msg1/A RACH, and/or the UE may select the CSI-RS/CSF configuration that aligns with the UE capability to provide the indication. The techniques described herein also provide the list of various metrics that support the CSI-RS reception/CSF capabilities the UE indicates in the uplink signals and/or messages.

For example, the UE may transmit or otherwise output (and the gNB may receive or otherwise obtain) a message that carries or otherwise conveys information indicative of support for an early CSI measurement and reporting procedure. In the example shown in FIG. 2, the message indicating the support for the early CSI measurement and reporting procedure may be transmitted in a Msg1 205. For example, the UE may transmit the indication in the Msg1 205 during the RACH procedure to (re)establish a wireless connection with the gNB.

It is to be understood that various metrics and/or other information may be provided by the UE to indicate its support for the early CSI measurement and reporting procedure, with such metrics being reported independently and/or in any combination. Thus, the CSI-RS reception and/or CSF capability that the UE indicates in the uplink signals and/or messages before the RRC connection setup complete message may include a number of different parameters. The UE may not be required to indicate all the parameters but rather the parameters the gNB is interested in to support the early CSI measurement and reporting procedure with the UE.

One such parameter or metric may include a CSI-RS reception feature list. The feature list may include a support for CSI-RS and CSI-IM reception for CSI feedback. The feature list may identify the supported maximum number of configured NZP-CSI-RS resources per CC. The feature list may identify the supported maximum number of ports across all configured NZP-CSI-RS resources per CC. The feature list may identify the supported maximum number of configured CSI-IM resources per CC. The feature list may identify the supported maximum number of simultaneous NZP-CSI-RS resources in active BWP(s) across all CCs. The feature list may identify the supported maximum number of simultaneous NZP-CSI-RS resources per CC. The feature list may identify the supported maximum total number of CSI-RS ports in simultaneous NZP-CSI-RS resources in active BWP(s) across all CCs. The feature list may identify the supported maximum total number of CSI-RS ports in simultaneous NZP-CSI-RS resources per CC.

In some cases, the indication of support for the early CSI measurement and reporting procedure may include the supported PDSCH re-mapping patterns. The re-mapping patterns may identify the supported maximum number of resource element (RE) mapping patterns where each pattern can be described as a resource (including NZP/ZP CSI-RS and CRS, control resource set (CORESET), SSB, and bitmap configured). In some aspects, the re-mapping patterns may be counted as per-symbol and/or per-CC. The re-mapping patterns may identify the supported maximum number of RE mapping patterns where each pattern can be described as a resource (including NZP/ZP CSI-RS and CRS, CORESET, SSB, and bitmap configured). In some cases, the re-mapping patterns may be counted as per-slot and/or per-CC. In some cases, the indication of support for the early CSI measurement and reporting procedure may include an indication of support for a semi-persistent CSI-RS.

In some cases, the indication of support for the early CSI measurement and reporting procedure may include an indication of support for a semi-persistent CSI report being provided via PUCCH, a semi-persistent CSI report being provided via PUSCH, and/or a new channel quality indicator (CQI) table being applied. In some cases, the indication of support for the early CSI measurement and reporting procedure may include an indication of support for a CSI report framework. The CSI report frameworks may include an indication of support for a maximum number of periodic CSI report setting per-BWP for the CSI report. The CSI report frameworks may include an indication of support for a maximum number of periodic CSI report settings per-BWP for a beam report. The CSI report frameworks may include an indication of support for a maximum number of aperiodic CSI report settings per-BWP for the CSI report. The CSI report frameworks may include an indication of support for a maximum number of aperiodic CSI report settings per-BWP for a beam report. The CSI report frameworks may include an indication of support for a maximum number of configured aperiodic CSI triggering states in a CSIAperiodicTriggerStateList IE per-CC. The CSI report frameworks may include an indication of support for a maximum number of semi-persistent CSI report settings per-BWP for the CSI report. The CSI report frameworks may include an indication of support for a maximum number of semi-persistent CSI report settings per-BWP for a beam report.

In some cases, the UE may process Y CSI report(s) simultaneously in a CC where the CSI reports can be periodic, semi-persistent, and/or aperiodic in nature and use any latency class and codebook type. In some cases, the UE can process X CSI report(s) simultaneously across all CCs where the CSI report(s) can be periodic, semi-persistent, and/or aperiodic in nature and use any latency class and codebook type.

In some cases, the indication of support for the early CSI measurement and reporting procedure may include an indication of support for semi-open loop CSI, for a CSI report without PMI, for a CSI report without CQI, for a Type II semi-persistent CSI feedback on a long PUCCH, and the like.

In some cases, the indication of support for the early CSI measurement and reporting procedure may include an indication of support for a Type I single panel codebook. For example, this may include a list of supported combinations with each combination being {maximum number of transmit ports in one resource, maximum number of resources and total number of transmit ports} across all CCs simultaneously. In some aspects, this list may not differentiate the latency class and feedback type. In some examples, this may include the supported codebook mode(s). In some examples, this may include the maximum number of CSI-RS resource(s) in a resource set.

In some cases, the indication of support for the early CSI measurement and reporting procedure may include an indication of support for a Type I multi-panel codebook. This may include a list of supported combinations with each combination being {maximum number of transmit ports in one resource, maximum number of resources and total number of transmit ports} across all CCs simultaneously. In some cases, this list may not differentiate the latency class and feedback type. In some cases, the list may include a supported codebook mode(s), a supported number of panels (Ng), and/or a maximum number of CSI-RS resource(s) in a resource set.

In some cases, the indication of support for the early CSI measurement and reporting procedure may include an indication of support for Type II codebook. For example, this may include a list of supported combinations with each combination being {maximum number of transmit ports in one resource, maximum number of resources and total number of transmit ports} across all CCs simultaneously. In some examples, this list may not differentiate the latency class and feedback type. In some examples, this may include a parameter “Lx” that identifies a number of beams used in the codebook generation, where x is an index of transmit ports corresponding to 4, 8, 12, 16, 24, and/or 32 ports. In some examples, this may include support for an amplitude scaling type and/or support for an amplitude subset restriction level.

In some cases, the indication of support for the early CSI measurement and reporting procedure may include an indication of support for Type II codebook with port selection. For example, this may include a list of supported combinations with each combination being {maximum number of transmit ports in one resource, maximum number of resources and total number of transmit ports} across all CCs simultaneously. In some cases, this list may not differentiate the latency class and feedback type. In some examples, the indication of support may include a parameter “Lx” that identifies the number of selected ports being used in the codebook generation, where x is an index of transmit ports, corresponding to 4, 8, 12, 16, 24, and/or 32 ports. In some cases, the indication of support may include an indication of support for an amplitude scaling type.

In some cases, the indication of support for the early CSI measurement and reporting procedure may include an indication of support for an enhanced multiple input/multiple output (eMIMO) CSF feature list. This may include an extension of the maximum number of configured aperiodic CSI report settings (e.g., an extension of the maximum number of configured aperiodic CSI report settings for all codebook types). In some cases, the indication of support for the early CSI measurement and reporting procedure may include an indication of support for a further eMIMO (FeMIMO) CSF feature list. For example, this may include an indication of support for an aperiodic CSI report (e.g., support of A-CSI report on two PUSCH repetitions) and/or support for semi-persistent CSI report (e.g., support of a semi-persistent CSI report on two PUSCH repetitions).

Accordingly, the UE may transmit any combination of such metrics and/or parameters associated with its support for the early CSI measurement and reporting procedure to the gNB in the message (e.g., the Msg1 205, in this example) during the RACH procedure with the gNB. In some cases, the UE may report its capabilities for supporting the early CSI measurement and reporting procedure by selecting resource(s) of a RACH occasion (RO) that corresponds to the level of support for the early CSI measurement and reporting procedure. As shown in FIG. 2, in some cases different RO resources may be mapped to an indication of the level of support of the UE for the early CSI measurement and reporting procedure. For example, a first RO (RO1) may be mapped to a level of support corresponding to a maximum number of CSI-RS ports being eight, a second RO (RO2) may be mapped to a level of support corresponding to a maximum number of CSI-RS ports being sixteen, and a third RO (RO3) may be mapped to a level of support corresponding to a maximum number of CSI-RS ports being 24. Thus, the UE may indicate its level of support by selecting a RO that is mapped to, and therefore corresponds to its level of support, for transmission of the Msg1 205.

The UE may receive or otherwise obtain (and the gNB may transmit or otherwise output) a signal that configures CSI-RS transmission(s) based at least in part on the message (e.g., the Msg1 205 that indicates the support for the early CSI measurement and reporting procedure). In the example shown in FIG. 2, the signal indicating the configuration for the CSI-RS transmission(s) includes the Msg2 210 that identifies and/or otherwise indicates the CSI-RS transmission(s) to be performed by the gNB. That is, the signal configuring the CSI-RS transmissions may be transmitted during the RACH procedure between the UE and the gNB. Accordingly, the gNB may transmit or otherwise output (and the UE may receive or otherwise obtain) the CSI-RS 215 that was scheduled by the Msg2 210. The UE may use the CSI-RS 215 to perform the early CSI measurement and reporting procedure. For example, the UE may measure the CSI-RS 215 to identify or otherwise determine various channel performance metrics, such as the reference signal received power (RSRP), the reference signal received quality (RSRQ), the signal-to-noise interference ratio (SINR), and the like. The UE may transmit or otherwise output a CSI report to the gNB that carries or otherwise conveys information associated with a result of such measurements.

For example, the UE may transmit or otherwise output (and the gNB may receive or otherwise obtain) a Msg3 220 that, in this example, carries or otherwise conveys the CSF (e.g., the CSI report based on the CSI-RS 215). The gNB may receive the CSF provided by the UE during the RACH procedure and update its parameter and/or allocation decisions based on the channel performance metrics indicated in the CSF. For example, the gNB may transmit or otherwise output (and the UE may receive or otherwise obtain) a Msg4 225 during the RACH procedure. However, in this case the gNB may have adopted a precoding using a Type I PMI based on the CSF provided by the UE. This may improve communicating the Msg4 225 to the UE based on the actual channel performance. The UE may transmit or otherwise output (and the gNB may receive or otherwise obtain) a Msg5 230 based at least in part on the Msg4 225. In some cases, the Msg5 230 may be a message that carries or otherwise conveys an RRC setup complete message. Thus, in this example the UE and the gNB may perform the early CSI measurement and reporting procedure during the RACH procedure and prior to reception of the RRC setup complete message associated with the RACH procedure.

Thus, diagram 200 illustrates one example to enable early CSI-RS based CSI acquisition where the UE indicates the CSI-RS reception/CSF capabilities in uplink signals and/or messages at least before the RRC connection setup complete message. To enhance the initial access coverage (e.g., by optimizing the rank indicator (RI), the precoding matrix indicator (PMI), and/or the CQI for Msg2/B/4), the gNB may configure and/or otherwise schedule the early CSI-RS for CSF. As discussed, the early CSI-RS reception/CSF may be up to or otherwise based on the UE capability (e.g., the maximum number of CSI-RS ports, resources, etc.) that the UE can measure. For the gNB to know the UE capabilities before the RRC connection setup complete message, the UE may indicate the CSI-RS reception/CSF capabilities in the uplink signals and/or messages, such as in the Msg1/MsgA RACH, in the MsgA/Msg3 PUSCH, etc. The early CSI-RS for CSF may therefore be configured and/or otherwise scheduled based on the CSI-RS reception/CSF capabilities reported by the UE (e.g., the CSI-RS/CSF configuration may not exceed the CSI-RS reception/CSF capabilities reported by the UE).

Additionally, or alternatively, aspects of the techniques described herein may also provide for improved flexibility with respect to the SSB periodicity and/or synchronization raster. The SSB is generally used for initial synchronization and cell search by the UE. The SSB may include a primary synchronization signal (PSS), a secondary synchronization signal (SSS), and a physical broadcast channel (PBCH). The PSS is generally used for initial timing and frequency synchronization with the gNB. The SSS is generally used for additional synchronization information and may include the cell identifier. The PBCH may carry the master information block (MIB) and the system information block one (SIB1) message. The PBCH may carry additional system information, which may include the parameters needed for further communications.

In some wireless networks, during the initial cell search procedure the SSB periodicity is assumed to be 20 ms while the synchronization raster is defined separately for the <3 GHz frequency band and the >3 GHz frequency band. However, in some scenarios such a universal SSB periodicity and synchronization raster (e.g., the same synchronization raster across the 3-24.25 GHz frequency band) may be too coarse. Accordingly, aspects of the techniques described herein improve the efficiency of the initial cell search procedure by making the SSB periodicity and/or the synchronization raster of the SSB based on the frequency range, based on the frequency bands, and the like.

For example, the UE may monitor for a SSB transmission according to an SSB periodicity and synchronization raster configuration associated with a plurality of SSB transmissions. However, in this scenario the parameter(s) of the SSB periodicity and synchronization raster configuration may be based on a frequency range, on a frequency band, on a subcarrier spacing (SCS), or any combination thereof, associated with the plurality of SSB transmissions. For example, the UE may receive at least one SSB transmission according to the SSB periodicity and synchronization raster configuration and perform a RACH procedure based at least in part on the at least one SSB transmission.

Thus, in some cases the SSB periodicity may be dependent on the frequency ranges (FRs), on the frequency bands, on the SCS, and the like. As one example, the SSB periodicity may be X ms in a sub-1 GHz frequency range, Y ms in a 1-6 GHz frequency range, and Z ms in a mmW frequency range. Thus, in this example the parameter(s) of the SSB periodicity and synchronization raster configuration may correspond to the SSB periodicity.

In some cases, the synchronization raster spacing may be dependent on the frequency ranges, the frequency bands, and/or SCS of the SSB and/or the initial BWP. For example, the synchronization raster spacing is sparser in the >6 GHz frequency band. As another example, the synchronization raster spacing may be sparser in the high frequency bands with large SCSs. Accordingly, in this example the parameter(s) of the SSB periodicity and synchronization raster configuration may correspond to the synchronization raster spacing associated with the plurality of SSBs.

In some cases, the SSB periodicity and/or synchronization raster spacing may be indicated by the gNB instead of only being predefined according to the parameter(s). For example, the UE camping on a particular gNB may further simplify the neighboring cell search procedure using a sparser sync raster spacing. For example, the gNB may transmit or otherwise output (and the UE may receive or otherwise obtain) a configuration message that identifies the parameter(s) of the SSB periodicity and synchronization raster configuration for the UE.

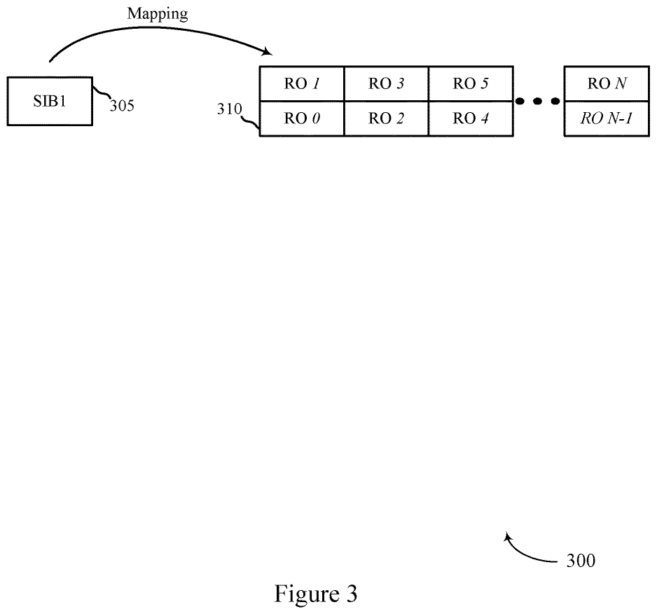

FIG. 3 shows an example of a diagram 300 that supports UE capability indication for early CSI-RS based CSI acquisition. Aspects of the diagram 300 may be implemented by aspects of and/or may implement aspects of the wireless communication system 100. For example, aspects of the diagram 300 may be implemented by and/or may be implemented at a UE or a network entity (e.g., a gNB), which may be examples of the corresponding devices described herein.

Aspects of the described techniques may support the UE and network acquiring the CSI as early as possible where the gNB may configure and/or schedule the early CSI-RS for CSF at least before the RRC connection setup complete message. After the UE reports the CSI metrics (e.g., the CSI report in CSF), the gNB may optimize the precoder, MCS, etc., for downlink messages, such as the RACH Msg2, the RACH Msg4, and/or the RACH MsgB. In some aspects, the described techniques for CSI-RS reception and CSF may be based on the UE capabilities, such as the maximum number of CSI-RS ports, resources, etc., that the UE can measure. For the gNB to know the UE capability before the RRC connection setup complete message, the UE may indicate the CSI-RS reception/CSF capability in uplink signals and/or messages, such as in the RACH Msg1 via the RACH, the RACH MsgA via the RACH, the RACH MsgA via the PUSCH, and/or the RACH Msg3 via the PUSCH.

Accordingly, the techniques described herein provide for a UE capability indication scheme that supports early CSI-RS-based CSI acquisition. In some cases, this may include the UE indicating the CSI-RS reception/CSF capabilities in uplink signals and/or messages at least before the RRC connection setup complete message. The UE may provide the capability indication in a RACH Msg1/MsgA RACH, in a MsgA/Msg3 PUSCH, in an enhanced Msg1/MsgA RACH, and/or the UE may select the CSI-RS/CSF configuration that aligns with the UE capability to provide the indication. The techniques described herein also provide the list of various metrics that support the CSI-RS reception/CSF capabilities the UE indicates in the uplink signals and/or messages.

For example, the UE may transmit or otherwise output (and the gNB may receive or otherwise obtain) a message that carries or otherwise conveys information indicative of a support for an early CSI measurement and reporting procedure. For example, the UE may transmit the indication in the Msg1 and/or in the Msg3 in the four-step RACH procedure or in the MsgA in the two-step RACH procedure and during the RACH procedure to (re)establish a wireless connection with the gNB.

The UE may receive or otherwise obtain (and the gNB may transmit or otherwise output) a signal that configures CSI-RS transmission(s) based at least in part on the message (e.g., the Msg1, Msg3, and/or MsgA that indicates the support for the early CSI measurement and reporting procedure). The signal indicating the configuration for the CSI-RS transmission(s) may identify and/or otherwise indicate the CSI-RS transmission(s) to be performed by the gNB. That is, the signal configuring the CSI-RS transmissions may be transmitted during the RACH procedure between the UE and the gNB. Accordingly, the gNB may transmit or otherwise output (and the UE may receive or otherwise obtain) the CSI-RS that was scheduled by the signal. The UE may use the CSI-RS to perform the early CSI measurement and reporting procedure. For example, the UE may measure the CSI-RS to identify or otherwise determine various channel performance metrics, such as the RSRP, the RSRQ, the SINR, and the like. The UE may transmit or otherwise output a CSI report to the gNB that carries or otherwise conveys information associated with a result of such measurements.

FIG. 3 illustrates an example where, to indicate the CSI-RS reception/CSF capability in the uplink signals and/or messages before the RRC connection setup complete message, different operations may be adopted. One option may include the UE indicating its CSI-RS reception/CSF capabilities by selecting the corresponding RACH resource for the Msg1/MsgA RACH. First, the gNB may configure the mapping between multiple CSI-RS reception/CSF capability candidates and RACH resources that consist of the RO, preamble ID, number of Msg1 repetition, etc., in the MIB/SIB. This mapping may include a first RO (e.g., RO 0) being mapped to totalNumberPortsSimultaneousNZP-CSI-RS-PerCC=8, a second RO (e.g., RO 1) being mapped to totalNumberPortsSimultaneousNZP-CSI-RS-PerCC=16, a third RO (e.g., RO 2) being mapped to totalNumberPortsSimultaneousNZP-CSI-RS-PerCC=24, and so forth until an Nth RO (e.g., RO N) being mapped to a fallback, i.e., no CSI-RS reception/CSF capability indication.

Then, the UE may select the corresponding RACH resource to indicate its CSI-RS reception/CSF capabilities. That is, the UE may select the resource(s) for the RO that corresponds to the level of support for the early CSI measurement and reporting procedure. In this example, the gNB may indicate the mapping between the RO resources and the corresponding level of support in a SIB1 305 that maps each RO 310 to a corresponding level of support.

Although the example shown in FIG. 3 illustrates a mapping between a RO 310 and a corresponding level of support for the maximum number of ports, it is to be understood that the mapping may be applied for any UE capability related to the early CSI measurement and reporting procedure. For example, the mapping may be between the resources of the ROs and any capability metric or information discussed above with reference to FIG. 2.

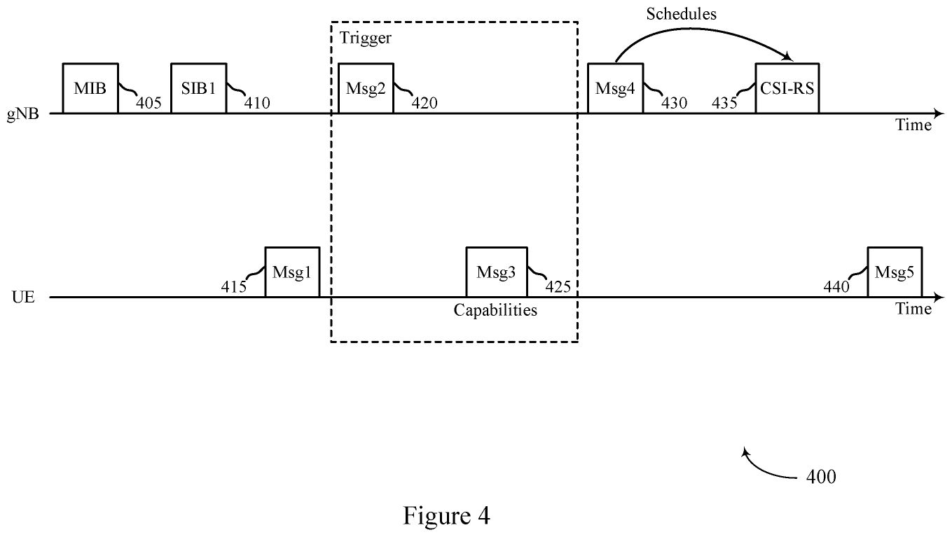

FIG. 4 shows an example of a diagram 400 that supports UE capability indication for early CSI-RS based CSI acquisition. Aspects of the diagram 400 may be implemented by aspects of and/or may implement aspects of the wireless communication system 100. For example, aspects of the diagram 400 may be implemented by and/or may be implemented at a UE or a network entity (e.g., a gNB), which may be examples of the corresponding devices described herein.

The described techniques may provide for the UE to transmit or otherwise output (and the gNB to receive or otherwise obtain) a message that carries or otherwise conveys information indicative of a support for an early CSI measurement and reporting procedure. For example, the UE may transmit the indication in the Msg1 and/or in the Msg3 in the four-step RACH procedure or in the MsgA in the two-step RACH procedure and during the RACH procedure to (re)establish a wireless connection with the gNB. The UE may receive or otherwise obtain (and the gNB may transmit or otherwise output) a signal that configures CSI-RS transmission(s) based at least in part on the message (e.g., the Msg1, Msg3, and/or MsgA that indicates the support for the early CSI measurement and reporting procedure).

The signal indicating the configuration for the CSI-RS transmission(s) may identify and/or otherwise indicate the CSI-RS transmission(s) to be performed by the gNB. That is, the signal configuring the CSI-RS transmissions may be transmitted during the RACH procedure between the UE and the gNB. Accordingly, the gNB may transmit or otherwise output (and the UE may receive or otherwise obtain) the CSI-RS that was scheduled by the signal. The UE may use the CSI-RS to perform the early CSI measurement and reporting procedure. For example, the UE may measure the CSI-RS to identify or otherwise determine various channel performance metrics, such as the RSRP, the RSRQ, the SINR, and the like. The UE may transmit or otherwise output a CSI report to the gNB that carries or otherwise conveys information associated with a result of such measurements.

FIG. 4 shows an example where the UE indicates the CSI-RS reception/CSF capabilities in the MsgA/Msg3 PUSCH in response to an inquiry about the CSI-RS reception/CSF capabilities received in the MIB 405, in the SIB1 410, and/or in the Msg2 420. For example, the gNB may trigger reporting about the csi-RS-IM-ReceptionForFeedback, the csi-ReportFramework, the Type I single panel codebook (e.g., the maxNumberTxPortsPerResource, maxNumberResourcesPerBand, etc., modes), and the like, from the UE. For the four-step RACH procedure, the gNB inquiry may be sent in the MIB 405, in the SIB1 410, and/or in the Msg2 420, with the UE response being sent in the Msg3 425. For the two-step RACH procedure, the gNB inquiry may be sent in the MIB 405 and/or the SIB1 410, with the UE response being sent in the MsgA PUSCH.

For example, the gNB may transmit or otherwise output (and the UE may receive or otherwise obtain) a MIB 405 and a SIB1 410 (e.g., as part of the SSB transmission from the gNB). The MIB 405 and the SIB1 410 may be used by the UE for initial cell time and/or frequency synchronization purposes. The UE may transmit or otherwise output (and the gNB may receive or otherwise obtain) a Msg1 415 that initiates the RACH procedure (e.g., to (re)establish a connection between the UE and the gNB).

The gNB may transmit or otherwise output (and the UE may receive or otherwise obtain) a Msg2 420 during the RACH procedure. In this example, the Msg2 420 may carry or otherwise convey the inquiry from the gNB regarding the UE capabilities to support the early CSI measurement and reporting procedure. For example, the UE may receive a message that triggers reporting of information associated with the support for the early CSI measurement and reporting procedure. In this example, the message is received in the Msg2 420 from the gNB. However, in other examples the message may be received in the MIB 405 or in the SIB1 410.

The UE may transmit or otherwise output (and the gNB may receive or otherwise obtain) a Msg3 425 during the RACH procedure. In this example, the Msg3 425 includes the message that carries or otherwise conveys the information indicative of the support for the early CSI measurement and reporting procedure. The information indicative of the support for the early CSI measurement and reporting procedure included in the Msg3 425 may be provided in response to the inquiry received from the gNB (e.g., in the Msg2 420, in this example).

Accordingly, the gNB may transmit or otherwise output (and the UE may receive or otherwise obtain) a Msg4 430. In this example, the Msg4 430 may include a signal that configures the CSI-RS transmission(s) for the UE (e.g., schedules the CSI-RS transmissions to the UE). The gNB may transmit or otherwise output (and the UE may receive or otherwise obtain) the CSI-RS 435 according to the scheduling information indicated in the Msg4 430. The UE may perform various measurements of the CSI-RS 435 to identify CSF to be provided to the gNB. The UE may transmit or otherwise output (and the gNB may receive or otherwise obtain) a Msg5 440 during the RACH procedure (e.g., before a RRC setup complete message). The Msg5 440 may carry or otherwise convey the CSF from the UE based on the CSI-RS 435.

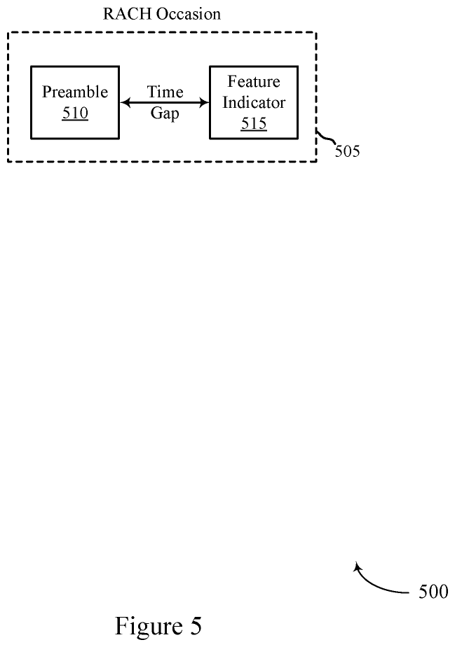

FIG. 5 shows an example of a diagram 500 that supports UE capability indication for early CSI-RS based CSI acquisition. Aspects of the diagram 500 may be implemented by aspects of and/or may implement aspects of the wireless communication system 100. For example, aspects of the diagram 500 may be implemented by and/or may be implemented at a UE or a network entity (e.g., a gNB), which may be examples of the corresponding devices described herein.

The described techniques may provide for the UE to transmit or otherwise output (and the gNB to receive or otherwise obtain) a message that carries or otherwise conveys information indicative of a support for an early CSI measurement and reporting procedure. For example, the UE may transmit the indication in the Msg1 and/or in the Msg3 in the four-step RACH procedure or in the MsgA in the two-step RACH procedure and during the RACH procedure to (re)establish a wireless connection with the gNB. The UE may receive or otherwise obtain (and the gNB may transmit or otherwise output) a signal that configures CSI-RS transmission(s) based at least in part on the message (e.g., the Msg1, Msg3, and/or MsgA that indicates the support for the early CSI measurement and reporting procedure).

The signal indicating the configuration for the CSI-RS transmission(s) may identify and/or otherwise indicate the CSI-RS transmission(s) to be performed by the gNB. That is, the signal configuring the CSI-RS transmissions may be transmitted during the RACH procedure between the UE and the gNB. Accordingly, the gNB may transmit or otherwise output (and the UE may receive or otherwise obtain) the CSI-RS that was scheduled by the signal. The UE may use the CSI-RS to perform the early CSI measurement and reporting procedure. For example, the UE may measure the CSI-RS to identify or otherwise determine various channel performance metrics, such as the RSRP, the RSRQ, the SINR, and the like. The UE may transmit or otherwise output a CSI report to the gNB that carries or otherwise conveys information associated with a result of such measurements.

FIG. 5 shows an example where the UE indicates the CSI-RS reception/CSF capabilities in the RACH Msg1 and/or in the RACH MsgA using a feature indicator. That is, the message that includes the information indicative of the support for the early CSI measurement and reporting procedure may be transmitted in the RACH Msg1/MsgA during a RO 505. In this example, the RACH Msg1/MsgA transmission may include a preamble 510 randomly selected by the UE along with a feature indicator 515 that carries or otherwise indicates the support for the early CSI measurement and reporting procedure. That is, in this example the message is transmitted in a Msg1/MsgA of the RACH procedure and the information indicative of the support for the early CSI measurement and reporting procedure is indicated in a feature indicator portion of the Msg1/MsgA.

Thus, in this example the UE indicates the CSI-RS reception/CSF capability by selecting the corresponding feature indicator sequence for an enhanced Msg1/MsgA RACH. The enhanced Msg1/MsgA RACH consists of the legacy preamble (e.g., the preamble 510) and the feature indicator (e.g., the feature indicator 515) dedicated to the UE capability indication. Similar to the preamble, the feature indicator may correspond to a sequence, such as the Zadoff-Chu (ZC) sequence, a pseudo-noise (PN) sequence, etc. After the gNB configures the mapping between multiple UE capability candidates and feature indicator sequences in the MIB/SIB, the UE may select the corresponding feature indicator sequence to indicate the UE capabilities. Thus, the UE may indicate the CSI-RS reception/CSF capabilities using the enhanced Msg1/MsgA RACH.

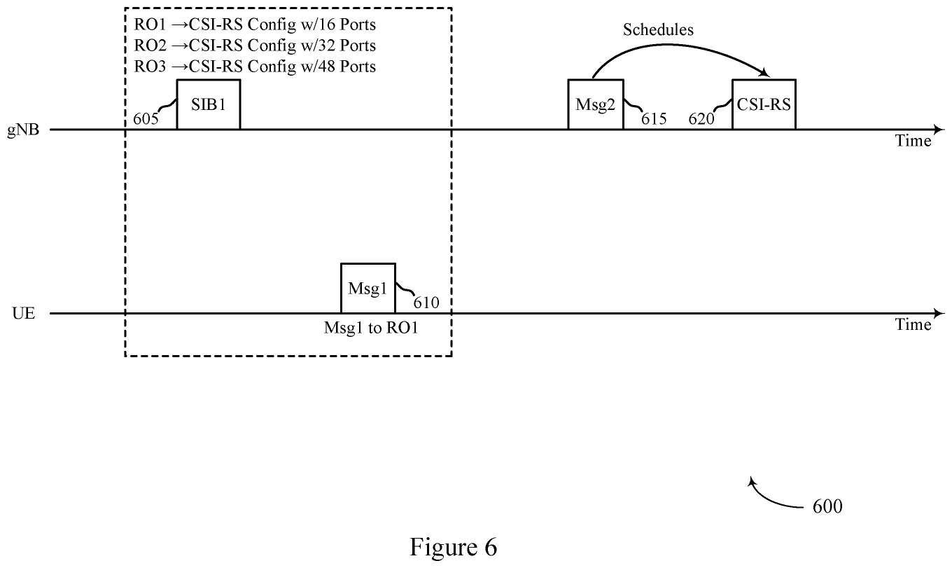

FIG. 6 shows an example of a diagram 600 that supports UE capability indication for early CSI-RS based CSI acquisition. Aspects of the diagram 600 may be implemented by aspects of and/or may implement aspects of the wireless communication system 100. For example, aspects of the diagram 600 may be implemented by and/or may be implemented at a UE or a network entity (e.g., a gNB), which may be examples of the corresponding devices described herein.

The described techniques may provide for the UE to transmit or otherwise output (and the gNB to receive or otherwise obtain) a message that carries or otherwise conveys information indicative of a support for an early CSI measurement and reporting procedure. For example, the UE may transmit the indication in the Msg1 and/or in the Msg3 in the four-step RACH procedure or in the MsgA in the two-step RACH procedure and during the RACH procedure to (re)establish a wireless connection with the gNB. The UE may receive or otherwise obtain (and the gNB may transmit or otherwise output) a signal that configures CSI-RS transmission(s) based at least in part on the message (e.g., the Msg1, Msg3, and/or MsgA that indicates the support for the early CSI measurement and reporting procedure).

The signal indicating the configuration for the CSI-RS transmission(s) may identify and/or otherwise indicate the CSI-RS transmission(s) to be performed by the gNB. That is, the signal configuring the CSI-RS transmissions may be transmitted during the RACH procedure between the UE and the gNB. Accordingly, the gNB may transmit or otherwise output (and the UE may receive or otherwise obtain) the CSI-RS that was scheduled by the signal. The UE may use the CSI-RS to perform the early CSI measurement and reporting procedure. For example, the UE may measure the CSI-RS to identify or otherwise determine various channel performance metrics, such as the RSRP, the RSRQ, the SINR, and the like. The UE may transmit or otherwise output a CSI report to the gNB that carries or otherwise conveys information associated with the result of such measurements.

FIG. 6 shows an example where, instead of indicating the CSI-RS reception/CSF capabilities, the UE selects the CSI-RS/CSF configuration that aligns with the UE's capabilities to support the early CSI measurement and reporting procedure. For example, the gNB may transmit or otherwise output (and the UE may receive or otherwise obtain) a configuration message that identifies a set of CSI feedback configurations available for the early CSI measurement and reporting procedure. In this example, the configuration message may correspond to a SIB1 605 transmitted from the gNB to the UE. Accordingly, first the gNB may advertise multiple CSI-RS/CSF configuration candidates in the MIB, in the SIB, and/or in the Msg2 during the RACH procedure. As shown in FIG. 6, the first RO (e.g., RO1) may be mapped to a first CSI-RS configuration with 16 ports (e.g., a first CSI feedback configuration), a second RO (e.g., RO2) to a CSI-RS configuration with 32 ports (e.g., a second CSI feedback configuration), and a third RO (e.g., RO3) to a CSI-RS configuration with 48 ports (e.g., a third CSI feedback configuration).

Next, the UE may select the CSI-RS/CSF configuration that aligns with the UE's capabilities. For example, the UE may select a CSI feedback configuration from the set of CSI feedback configurations that corresponds to a level of UE support for the early CSI measurement and reporting procedures. In this example, the UE may select the RO corresponding to the UE level of support for the early CSI measurement and reporting procedure. For example, the UE may select the first RO to transmit or otherwise output (and the gNB may receive or otherwise obtain) a Msg1 610. The Msg1 610 being sent in the first RO may indicate the UE's capabilities to support the early CSI measurement and reporting procedure. That is, the gNB receiving the Msg1 610 in the first RO may know that the UE supports the early CSI measurement and reporting procedure (e.g., the CSI feedback configuration) associated with or otherwise using up to 16 ports.

In some aspects, the UE may use various techniques to select and/or indicate the CSI feedback configuration. One example may include the UE selecting the resource for the RO that corresponds to the CSI feedback configuration. That is, the UE may select the CSI-RS/CSF configuration by selecting the corresponding RACH resource for the RACH Msg1/MsgA RACH transmission. Another example may include the UE selecting the CSI feedback configuration by transmitting an indication of the CSI feedback configuration in a RACH Msg3 of the RACH procedure. That is, the UE may indicate which CSI-RS/CSF configuration that aligns with the UE's capabilities in the RACH MsgA/Msg3 RACH. Another example may include the UE selecting the CSI feedback configuration by selecting a feature indicator portion of the Msg1 of the RACH procedure that corresponds to the CSI feedback configuration. That is, the UE may select the CSI-RS/CSF configuration by selecting the corresponding feature indicator sequence that is included in the enhanced Msg1/MsgA RACH transmission.

The early CSI-RS for CSF may be configured and/or otherwise scheduled based on the CSI-RS/CSF configuration selected by the UE. For example, the gNB may transmit or otherwise output (and the UE may receive or otherwise obtain) a Msg2 615 that schedules or otherwise configures the CSI-RS transmission(s) to the UE. Accordingly, the gNB may transmit or otherwise output (and the UE may receive or otherwise obtain) the CSI-RS 620 according to the scheduling information indicated in the Msg2 615. The UE may use the CSI-RS 620 to perform the early CSI measurement and reporting procedure with the gNB and transmit a CSI report (e.g., the CSF) to the gNB during the RACH procedure (e.g., before the RRC setup complete message is received).

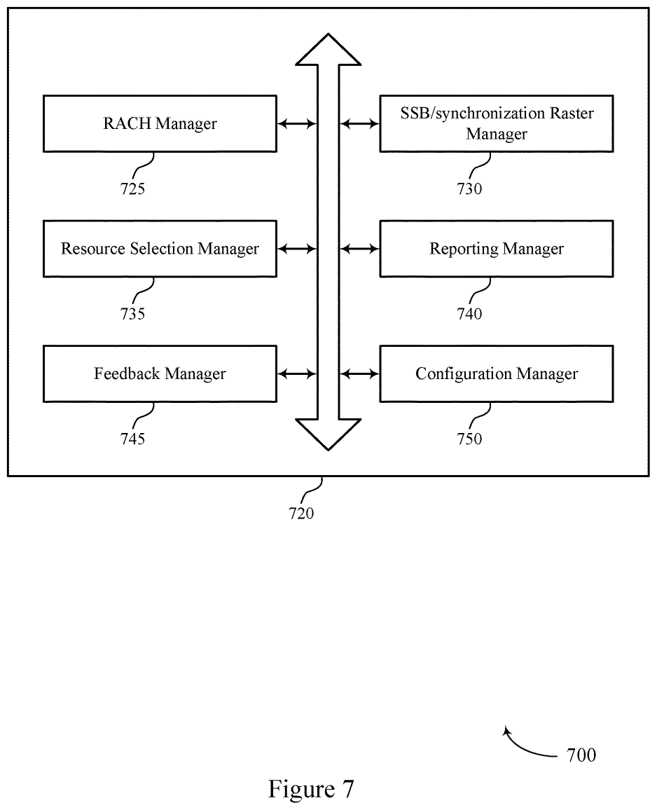

FIG. 7 shows an example of diagram 700 that includes a processing system 720 that supports UE capability indication for early CSI-RS based CSI acquisition. A processing system 720 may be an example of a processing system 140 (such as of a UE 115) and may include a RACH manager 725, a SSB/synchronization raster manager 730, a resource selection manager 735, a reporting manager 740, a feedback manager 745, a configuration manager 750, or any combination thereof. A processing system 720, or various component thereof, may be an example of means for performing (such as a means for causing a UE 115 to perform) various techniques described herein.

The RACH manager 725 may be configured to cause the UE 115 to transmit, during a RACH procedure, a message that includes information indicative of a support for an early CSI measurement and reporting procedure. In some examples, the RACH manager 725 may be configured to cause the UE 115 to receive, during the RACH procedure, a signal that configures one or more CSI-RS transmissions based on the message. In some examples, the RACH manager 725 may be configured to cause the UE 115 to perform, during the RACH procedure and prior to an RRC setup complete message associated with the RACH procedure, the early CSI measurement and reporting procedure using the one or more CSI-RS transmissions.

In some examples, to support transmitting the message, the resource selection manager 735 may be configured to cause the UE 115 to select resources of a RO that correspond to a level of support for the early CSI measurement and reporting procedure.

In some examples, the reporting manager 740 may be configured to cause the UE 115 to receive a second message that triggers reporting of information associated with the support for the early CSI measurement and reporting procedure, where transmitting the message is based on the second message. In some examples, the second message is received in at least one of a MIB message, in a SIB message, or in a Msg2 of the RACH procedure. In some examples, the message is transmitted in a Msg3 of the RACH procedure. In some examples, the message is transmitted in a Msg1 of the RACH procedure and the information indicative of the support for the early CSI measurement and reporting procedure is indicated in a feature indicator portion of the Msg1.

In some examples, to support transmitting the message, the feedback manager 745 may be configured to cause the UE 115 to receive a configuration message that identifies a set of CSI feedback configurations available for the early CSI measurement and reporting procedure. In some examples, to support transmitting the message, the feedback manager 745 may be configured to cause the UE 115 to select a CSI feedback configuration from the set of CSI feedback configurations that corresponds to a level of UE support for the early CSI measurement and reporting procedure.

In some examples, to support selecting the CSI feedback configuration, the feedback manager 745 may be configured to cause the UE 115 to select resources for a RO that corresponds to the CSI feedback configuration. In some examples, to support selecting the CSI feedback configuration, the feedback manager 745 may be configured to cause the UE 115 to transmit an indication of the CSI feedback configuration in a Msg3 of the RACH procedure. In some examples, to support selecting the CSI feedback configuration, the feedback manager 745 may be configured to cause the UE 115 to select a feature indicator portion of a Msg1 of the RACH procedure that corresponds to the CSI feedback configuration.

Additionally, or alternatively, the SSB/synchronization raster manager 730 may be configured to cause the UE 115 to monitor for a SSB transmission according to an SSB periodicity and synchronization raster configuration associated with a set of multiple SSB transmissions, where one or more parameters of the SSB periodicity and synchronization raster configuration are based on a frequency range, on a frequency band, on a SCS, or any combination thereof, associated with the set of multiple SSB transmissions. In some examples, the SSB/synchronization raster manager 730 may be configured to cause the UE 115 to receive at least one SSB transmission according to the SSB periodicity and synchronization raster configuration. In some examples, the SSB/synchronization raster manager 730 may be configured to cause the UE 115 to perform a RACH procedure based on the at least one SSB transmission.

In some examples, the one or more parameters include a periodicity of the set of multiple SSB transmissions according to the SSB periodicity and synchronization raster configuration. In some examples, the one or more parameters include a synchronization raster spacing associated with the set of multiple SSB transmissions according to the SSB periodicity and synchronization raster configuration.

In some examples, the configuration manager 750 may be configured to cause the UE 115 to receive a configuration message that identifies the one or more parameters of the SSB periodicity and synchronization raster configuration.

A processing system 720 may include or be a component of one or more chips, systems-on-chips (SoCs), chipsets, packages, components, or devices that individually or collectively constitute or include a processing system. A processing system 720 may interface with other components of a processing system 720. For example, operations described with reference to a processing system 720, or various components thereof, may be performed by or with other such components, including a receiver, a transmitter, a transceiver, a modem, a user interface, a modulator/demodulator, an encoder/decoder, or any combination thereof (such as of the processing system 720, coupled with the processing system 720, of a processing system 720).

By including or configuring a processing system 720 for operation in a processing system 720 as described herein, the processing system 720 may support techniques for improved initial access procedure between UE and the network. This may be based on an indication of support for an early CSI measurement and reporting procedure provided by the UE during the RACH procedure, where the gNB configures CSI-RS transmission(s) to the UE according to its indicated capabilities.

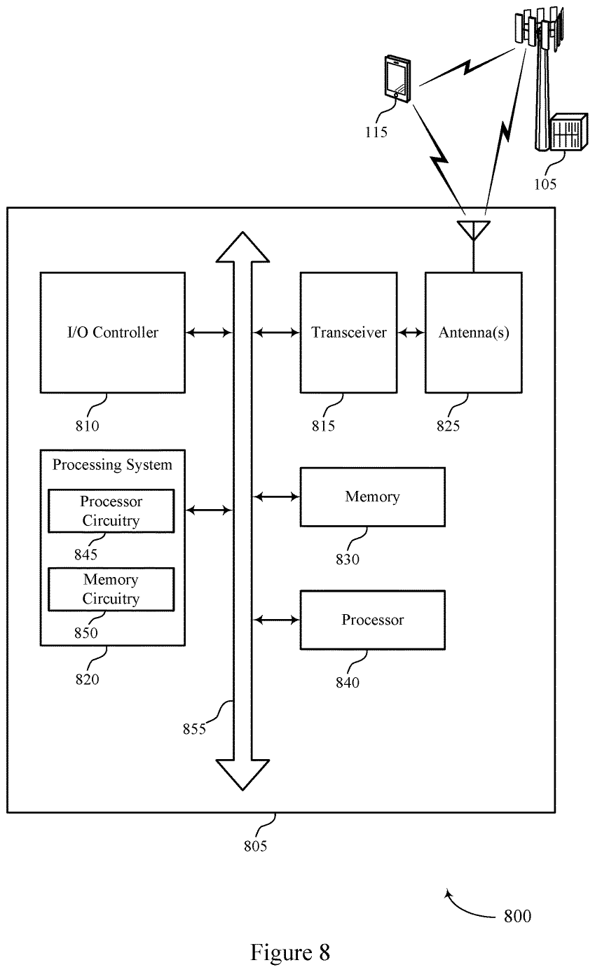

FIG. 8 shows an example of a system 800 including a device 805 that supports UE capability indication for early CSI-RS based CSI acquisition. The device 805 may be an example of or include components of UE 115. The device 805 may communicate (such as wirelessly) with one or more other devices (such as network entities 105, UEs 115). The device 805 may include components for transmitting and receiving communication, which may include a processing system 820, an input/output (I/O) controller, such as an I/O controller 810, a transceiver 815, antenna(s) 825, a memory 830, and a processor 840. Components of the device 805 may be coupled (such as operatively, communicatively, functionally, electronically, electrically, in electronic communication) with a bus 855.

The transceiver 815 may support bi-directional communication via antenna(s) 825, and may support transmission operations, reception operations, or both, as described herein. The transceiver 815 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 805). The transceiver 815 may modulate symbols and provide the modulated symbols to antenna(s) 825 for transmission, and demodulate symbols from signals received using antenna(s) 825.

The processor 840 may be a general-purpose processing component that supports various operations (such as applications) of the device 805. The memory 830 may be a general-purpose storage component that stores code executable by the processor 840. Such code may include instructions that, when executed by the processor 840, cause the device 805 to perform various functions (such as to support an application of the device 805). The I/O controller 810 may manage inputs and outputs for the device 805, may manage peripherals not integrated into the device 805, or may represent a physical connection (such as a port) to an external peripheral. The processor 840 may interact with a modem, a keyboard, a mouse, a touchscreen, or other device (such as via I/O controller 810). In some implementations, a user may interact with the device 805 via the I/O controller 810 or via hardware components controlled by the I/O controller 810.

The processing system 820 may be an example of a processing system 140 or a processing system 720. For example, the processing system 820 may include processor circuitry 845 and memory circuitry 850 that stores code, and may be configured to cause the device 805 to perform operations that support UE capability indication for early CSI-RS based CSI acquisition. Although the processing system 820 is illustrated as a separate component, which may involve a separate chip, chipset, or other module, in some implementations, one or more functions described with reference to the processing system 820 may be supported by or performed by a transceiver 815, antenna(s) 825, a processor 840, memory 830, or any combination thereof, such that a processing system 820 may include one or more of a transceiver 815, antenna(s) 825, a processor 840, memory 830, or any combination thereof.

By including or configuring the processing system 820 for operation in the device 805 as described herein, it may support techniques for improved initial access procedure between UE and the network. This may be based on an indication of support for an early CSI measurement and reporting procedure provided by the UE during the RACH procedure where the gNB configures CSI-RS transmission(s) to the UE according to its indicated capabilities.

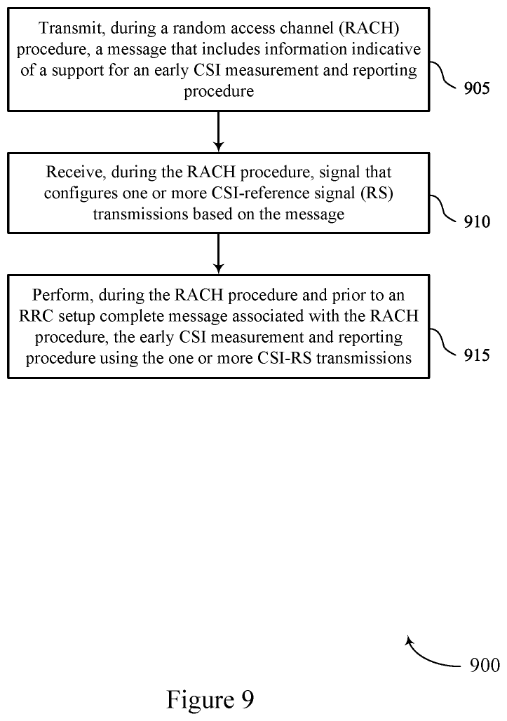

FIG. 9 shows an example of a method 900 that supports UE capability indication for early CSI-RS based CSI acquisition. Operations of the method 900 may be performed by a UE or its components (such as using a processing system configured to cause the UE 115 to perform one or more of the operations) as described herein.

At 905, the method may include transmitting, during a RACH procedure, a message that includes information indicative of a support for an early CSI measurement and reporting procedure. In some examples, aspects of the operations of 905 may be performed by a RACH manager 725.

At 910, the method may include receiving, during the RACH procedure, a signal that configures one or more CSI-RS transmissions based on the message. In some examples, aspects of the operations of 910 may be performed by a RACH manager 725.

At 915, the method may include performing, during the RACH procedure and prior to an RRC setup complete message associated with the RACH procedure, the early CSI measurement and reporting procedure using the one or more CSI-RS transmissions. In some examples, aspects of the operations of 915 may be performed by a RACH manager 725.

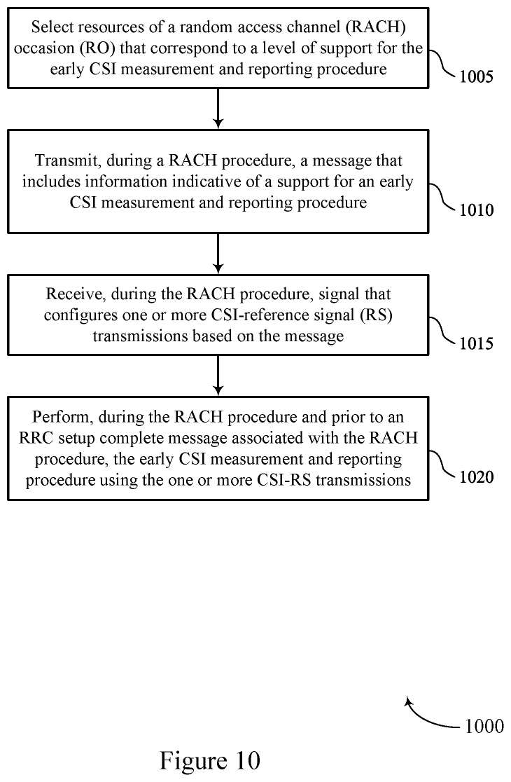

FIG. 10 shows an example of a method 1000 that supports UE capability indication for early CSI-RS based CSI acquisition. Operations of the method 1000 may be performed by a UE or its components (such as using a processing system configured to cause the UE 115 to perform one or more of the operations) as described herein.

At 1005, the method may include selecting resources of a RACH occasion (RO) that correspond to a level of support for the early CSI measurement and reporting procedure. In some examples, aspects of the operations of 1005 may be performed by a resource selection manager 735.

At 1010, the method may include transmitting, during a RACH procedure, a message that includes information indicative of a support for an early CSI measurement and reporting procedure. In some examples, aspects of the operations of 1010 may be performed by a RACH manager 725.

At 1015, the method may include receiving, during the RACH procedure, a signal that configures one or more CSI-RS transmissions based on the message. In some examples, aspects of the operations of 1015 may be performed by a RACH manager 725.

At 1020, the method may include performing, during the RACH procedure and prior to an RRC setup complete message associated with the RACH procedure, the early CSI measurement and reporting procedure using the one or more CSI-RS transmissions. In some examples, aspects of the operations of 1020 may be performed by a RACH manager 725.

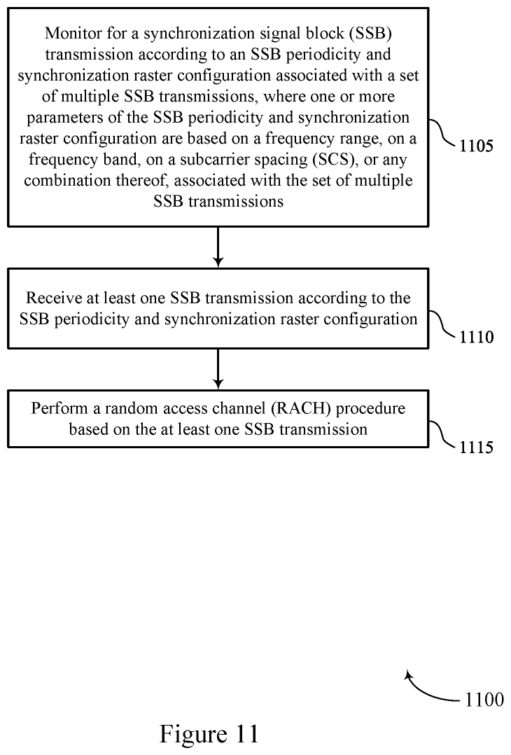

FIG. 11 shows an example of a method 1100 that supports UE capability indication for early CSI-RS based CSI acquisition. Operations of the method 1100 may be performed by a UE or its components (such as using a processing system configured to cause the UE 115 to perform one or more of the operations) as described herein.

At 1105, the method may include monitoring for a SSB transmission according to an SSB periodicity and synchronization raster configuration associated with a set of multiple SSB transmissions, where one or more parameters of the SSB periodicity and synchronization raster configuration are based on a frequency range, on a frequency band, on a SCS, or any combination thereof, associated with the set of multiple SSB transmissions. In some examples, aspects of the operations of 1105 may be performed by an SSB/synchronization raster manager 730.

At 1110, the method may include receiving at least one SSB transmission according to the SSB periodicity and synchronization raster configuration. In some examples, aspects of the operations of 1110 may be performed by an SSB/synchronization raster manager 730.

At 1115, the method may include performing a physical random access channel (RACH) procedure based on the at least one SSB transmission. In some examples, aspects of the operations of 1115 may be performed by an SSB/synchronization raster manager 730.

Implementation examples are described in the following numbered clauses:

Aspect 1: A method for wireless communications at a UE, comprising: transmitting, during a RACH procedure, a message that comprises information indicative of a support for an early CSI measurement and reporting procedure; receiving, during the RACH procedure, a signal that configures one or more CSI-RS transmissions based at least in part on the message; and performing, during the RACH procedure and prior to an RRC setup complete message associated with the RACH procedure, the early CSI measurement and reporting procedure using the one or more CSI-RS transmissions.

Aspect 2: The method of aspect 1, wherein transmitting the message comprises: selecting resources of a RO that correspond to a level of support for the early CSI measurement and reporting procedure.

Aspect 3: The method of any of aspects 1 through 2, further comprising: receiving a second message that triggers reporting of information associated with the support for the early CSI measurement and reporting procedure, wherein transmitting the message is based at least in part on the second message.

Aspect 4: The method of aspect 3, wherein the second message is received in at least one of a MIB message, in a SIB message, or in a Msg2 of the RACH procedure, and the message is transmitted in a Msg3 of the RACH procedure.

Aspect 5: The method of any of aspects 1 through 4, wherein the message is transmitted in a Msg1 of the RACH procedure and the information indicative of the support for the early CSI measurement and reporting procedure is indicated in a feature indicator portion of the Msg1.

Aspect 6: The method of any of aspects 1 through 5, wherein transmitting the message comprises: receiving a configuration message that identifies a set of CSI feedback configurations available for the early CSI measurement and reporting procedure; and selecting a CSI feedback configuration from the set of CSI feedback configurations that corresponds to a level of UE support for the early CSI measurement and reporting procedure.

Aspect 7: The method of aspect 6, wherein selecting the CSI feedback configuration comprises at least one of: selecting a resource for a RO that corresponds to the CSI feedback configuration, transmitting an indication of the CSI feedback configuration in a Msg3 of the RACH procedure, or selecting a feature indicator portion of a Msg1 of the RACH procedure that corresponds to the CSI feedback configuration.

Aspect 8: A method for wireless communications at a UE, comprising: monitoring for a SSB transmission according to an SSB periodicity and synchronization raster configuration associated with a plurality of SSB transmissions, wherein one or more parameters of the SSB periodicity and synchronization raster configuration are based at least in part on a frequency range, on a frequency band, on a SCS, or any combination thereof, associated with the plurality of SSB transmissions; receiving at least one SSB transmission according to the SSB periodicity and synchronization raster configuration; and performing a RACH procedure based at least in part on the at least one SSB transmission.

Aspect 9: The method of aspect 8, wherein the one or more parameters comprise a periodicity of the plurality of SSB transmissions according to the SSB periodicity and synchronization raster configuration.

Aspect 10: The method of any of aspects 8 through 9, wherein the one or more parameters comprise a synchronization raster spacing associated with the plurality of SSB transmissions according to the SSB periodicity and synchronization raster configuration.

Aspect 11: The method of any of aspects 8 through 10, further comprising: receiving a configuration message that identifies the one or more parameters of the SSB periodicity and synchronization raster configuration.

Aspect 12: A UE for wireless communications, comprising a processing system that includes processor circuitry and memory circuitry that stores code, the processing system configured to cause the UE to perform a method of any of aspects 1 through 7.

Aspect 13: A UE for wireless communications, comprising at least one means for performing a method of any of aspects 1 through 7.

Aspect 14: A non-transitory computer-readable medium storing code for wireless communications, the code comprising instructions executable by one or more processors to perform a method of any of aspects 1 through 7.

Aspect 15: A UE for wireless communications, comprising a processing system that includes processor circuitry and memory circuitry that stores code, the processing system configured to cause the UE to perform a method of any of aspects 8 through 11.

Aspect 16: A UE for wireless communications, comprising at least one means for performing a method of any of aspects 8 through 11.

Aspect 17: A non-transitory computer-readable medium storing code for wireless communications, the code comprising instructions executable by one or more processors to perform a method of any of aspects 8 through 11.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
transmit, during a random access channel (RACH) procedure, a message that comprises information indicative of a support for an early channel state information (CSI) measurement and reporting procedure;
receive, during the RACH procedure, a signal that configures one or more CSI-reference signal (RS) transmissions based at least in part on the message; and
perform, during the RACH procedure and prior to a radio resource control (RRC) setup complete message associated with the RACH procedure, the early CSI measurement and reporting procedure using the one or more CSI-RS transmissions.

2. The UE of claim 1, wherein, to transmit the message, the processing system is configured to cause the UE to:
select resources of a RACH occasion (RO) that correspond to a level of support for the early CSI measurement and reporting procedure.

3. The UE of claim 1, wherein the processing system is further configured to cause the UE to:
receive a second message that triggers reporting of information associated with the support for the early CSI measurement and reporting procedure, wherein transmitting the message is based at least in part on the second message.

4. The UE of claim 3, wherein:
the second message is received in at least one of a master information block (MIB) message, in a secondary information block (SIB) message, or in a message two (Msg2) of the RACH procedure, and
the message is transmitted in a message three (Msg3) of the RACH procedure.

5. The UE of claim 1, wherein the message is transmitted in a message one (Msg1) of the RACH procedure and the information indicative of the support for the early CSI measurement and reporting procedure is indicated in a feature indicator portion of the Msg1.

6. The UE of claim 1, wherein, to transmit the message, the processing system is configured to cause the UE to:
receive a configuration message that identifies a set of CSI feedback configurations available for the early CSI measurement and reporting procedure; and
select a CSI feedback configuration from the set of CSI feedback configurations that corresponds to a level of UE support for the early CSI measurement and reporting procedure.

7. The UE of claim 6, wherein the processing system is configured to cause the UE to:
select a resource for a RACH occasion (RO) that corresponds to the CSI feedback configuration,
transmit an indication of the CSI feedback configuration in a message three (Msg3) of the RACH procedure, or
select a feature indicator portion of a message one (Msg1) of the RACH procedure that corresponds to the CSI feedback configuration.

8. A method for wireless communications at a user equipment (UE), comprising:
transmitting, during a random access channel (RACH) procedure, a message that comprises information indicative of a support for an early channel state information (CSI) measurement and reporting procedure;
receiving, during the RACH procedure, a signal that configures one or more CSI-reference signal (RS) transmissions based at least in part on the message; and
performing, during the RACH procedure and prior to a radio resource control (RRC) setup complete message associated with the RACH procedure, the early CSI measurement and reporting procedure using the one or more CSI-RS transmissions.

9. The method of claim 8, wherein transmitting the message comprises:
selecting resources of a RACH occasion (RO) that correspond to a level of support for the early CSI measurement and reporting procedure.

10. The method of claim 8, further comprising:
receiving a second message that triggers reporting of information associated with the support for the early CSI measurement and reporting procedure, wherein transmitting the message is based at least in part on the second message.

11. The method of claim 10, wherein the second message is received in at least one of a master information block (MIB) message, in a secondary information block (SIB) message, or in a message two (Msg2) of the RACH procedure, and the message is transmitted in a message three (Msg3) of the RACH procedure.

12. The method of claim 8, wherein the message is transmitted in a message one (Msg1) of the RACH procedure and the information indicative of the support for the early CSI measurement and reporting procedure is indicated in a feature indicator portion of the Msg1.

13. The method of claim 8, wherein transmitting the message comprises:
receiving a configuration message that identifies a set of CSI feedback configurations available for the early CSI measurement and reporting procedure; and
selecting a CSI feedback configuration from the set of CSI feedback configurations that corresponds to a level of UE support for the early CSI measurement and reporting procedure.

14. The method of claim 13, wherein selecting the CSI feedback configuration comprises at least one of:
selecting a resource for a RACH occasion (RO) that corresponds to the CSI feedback configuration,
transmitting an indication of the CSI feedback configuration in a message three (Msg3) of the RACH procedure, or
selecting a feature indicator portion of a message one (Msg1) of the RACH procedure that corresponds to the CSI feedback configuration.

15. A non-transitory computer-readable medium storing code for wireless communications, the code comprising instructions executable by one or more processors to:
transmit, during a random access channel (RACH) procedure, a message that comprises information indicative of a support for an early channel state information (CSI) measurement and reporting procedure;
receive, during the RACH procedure, a signal that configures one or more CSI-reference signal (RS) transmissions based at least in part on the message; and
perform, during the RACH procedure and prior to a radio resource control (RRC) setup complete message associated with the RACH procedure, the early CSI measurement and reporting procedure using the one or more CSI-RS transmissions.

16. The non-transitory computer-readable medium of claim 15, wherein the instructions are further executable by the one or more processors to:
select resources of a RACH occasion (RO) that correspond to a level of support for the early CSI measurement and reporting procedure.

17. The non-transitory computer-readable medium of claim 15, wherein the instructions are further executable by the one or more processors to:
receive a second message that triggers reporting of information associated with the support for the early CSI measurement and reporting procedure, wherein transmitting the message is based at least in part on the second message.

18. The non-transitory computer-readable medium of claim 17, wherein the instructions are further executable by the one or more processors to:
the second message is received in at least one of a master information block (MIB) message, in a secondary information block (SIB) message, or in a message two (Msg2) of the RACH procedure, and
the message is transmitted in a message three (Msg3) of the RACH procedure.

19. The non-transitory computer-readable medium of claim 15, wherein the message is transmitted in a message one (Msg1) of the RACH procedure and the information indicative of the support for the early CSI measurement and reporting procedure is indicated in a feature indicator portion of the Msg1.

20. The non-transitory computer-readable medium of claim 15, wherein the instructions are further executable by the one or more processors to:
receive a configuration message that identifies a set of CSI feedback configurations available for the early CSI measurement and reporting procedure; and
select a CSI feedback configuration from the set of CSI feedback configurations that corresponds to a level of UE support for the early CSI measurement and reporting procedure.
